(19) United States
(12) Patent Application Publication
(10) Pub. No.: US 2010/0298968 A1
(43) Pub. Date: Nov. 25, 2010

(54) QUAY CRANE HATCH COVER SAFETY SYSTEM

(76) Inventors: Henry King, Moraga, CA (US); Toru Takehara, Foster City, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/784,475

(22) Filed: May 20, 2010

Related U.S. Application Data
(63) Continuation-in-part of application No. 12/748,354, filed on Mar. 26, 2010.
(60) Provisional application No. 61/180,113, filed on May 20, 2009.
(60) Provisional application No. 61/163,838, filed on Mar. 26, 2009.

(51) Int. Cl. B66C 15/06; G06F 19/00; B66C 19/00; B65G 67/60; G06F 15/00

(52) U.S. Cl. 700/213; 414/141.3; 212/276; 340/685; 702/127

(57) ABSTRACT

A safety device and a processor are disclosed for a quay crane, both are configured to avert the hatch cover being lifted from a ship as a container on the hatch is lifted. A computer readable memory and server are disclosed that may provide the processor with a program system and/or installation package. Motion sensors are disclosed for use with the safety device that may contribute to estimating the movement of the hatch cover.

### CROSS REFERENCE TO RELATED APPLICATIONS

This application claims priority to Provisional U.S. Patent Application No. 61/180,113 entitled “Hatch Detection Safety System” by inventors Henry King and Toni Takehara, filed May 20, 2009; and

this application is also a continuation in part of U.S. patent application Ser. No. 12/748,354, entitled “GANTRY CRANE TRUCK JOSTLE PREVENTION AND/OR HATCH COVER DETECTION” by the same inventors and filed Mar. 26, 2010, which claims priority to Provisional U.S. Patent Application No. 61/163,838 entitled “Crane Anti-Jostle System and Methods” by the same inventors, filed Mar. 26, 2009, with all of these documents incorporated herein by reference.

### TECHNICAL FIELD

This invention relates to avoiding lifting a hatch cover on a ship as a quay crane picks up a container.

### BACKGROUND OF THE INVENTION

Crane safety is a primary concern at shipyard where container handling quay cranes are used. One dangerous event occurs when the quay crane lifts a container that has not been properly decoupled from a hatch cover on a ship. The crane tends to lift both the container both the container and the hatch cover, which may also have other containers still on it, which may spill off, possibly being damaged themselves, possibly further sliding off the ship and landing on the dock, where the container may injure or kill people. Averting these dangerous events can save lives and reduce damage done to containers, ships and docks in shipyards.

Another dangerous event occurs when the quay crane lifts a container that has not been properly decoupled from its chassis and the truck driving it. The crane tends to lift both the chassis and the truck. Averting these dangerous events can save lives and reduce damage done to containers, chassis and trucks in container handling environments such as shipyards and container stacks.

Another problem, while not dangerous leads to added overhead in the management of quay cranes. Optical Character Recognition (OCR) systems employed to identify containers often get confused and fail to recognize a hatch cover, which do not have a container identifying code. This leads to added expense, while it has to be separately confirmed that the lifted object is a hatch cover and not a container.

Averting lifting a hatch cover with a container on a ship, averting lifting a truck and chassis when lifting the container from the chassis, and/or eliminating confusing a hatch cover for a container are problems that need solution.

### SUMMARY OF THE INVENTION

A safety device is claimed and disclosed for a quay crane configured to lift a container from a hatch cover on a ship. The safety device is configured to avert the hatch cover being lifted as shown in FIG. 1 in response to an indication that the container failed to decouple from the hatch cover. The indication that the container failed to decouple from the hatch cover may further include a second indication that the hatch cover is still coupled to at least one other container as shown in FIG. 2C.

The safety device may include a processor configured to respond to at least one signal to create the indication that the container failed to decouple from the hatch cover and to generate an alert in response to the indication when the container is being lifted off of the ship. The alert may include an audio alert, a visual alert, an engine stop signal, a ship alert, and a management system alert. The alert may contribute to any combination of averting the hatch cover being lifted, and/or warning at least one person the hatch cover is coupled to the container being lifted, and/or shutting down at least one equipment involved in lifting the container, and/or informing the ship and/or a management system that the hatch cover is coupled to the container being lifted.

The alert may be sent to the quay crane operational center, or cab, where it may trigger an hoist motor or engine shutdown to avert lifting the hatch cover, by stopping a spreader from lifting the container still coupled to the hatch cover. The crane operator situated in the cab may also be alerted by a visual alert message and/or an audio alert message. People on the loading platform of the dock, particularly those near the quay crane may be alerted by visual and/or audio alerts.

The indication that the hatch cover failed to decouple from the container being lifted may be created in several ways, and may be based upon one or more of a hatch cover movement estimate, a spreader load weight estimate, a hoist position, a hoist velocity, and a hoist motor power consumption. Any of these may be based upon the signals the processor may have received through interactions with a Programmable Logic Controller (PLC) interface, and/or a relay interface, and/or a wireline communications interface compatible with at least one wireline communications standard, and/or a wireless communications interface compatible with at least one wireless modulation-demodulation scheme.

At least one motion sensor may be configured to send the signal that at least partly creates the hatch cover movement estimate. The motion sensor may be configured to couple to the quay crane, and in some embodiments may be further configured to couple to the trolley and/or the cab of the quay crane. The motion sensor may include at least one source configured to produce an emission that reflects off of the hatch cover to create a reflection and at least one receiver configured to receive the reflection to at least partly create the hatch cover movement estimate. The emission may include at least one of an ultrasonic component, a microwave component, an infrared component, and a visible light component. The source and/or receiver for the visible light component may be a laser. The microwave component may involve a radar.

The processor may include at least one instance of a finite state machine, and/or a computer instructed by a program system including program steps residing in a memory accessibly coupled to the computer and/or an inferential engine.

The apparatus being claimed and disclosed also includes a computer readable memory and/or a server. The computer readable memory is configured for accessible coupling to the computer and includes the program system and/or an installation package to configure the memory in the processor with the program system. The server may be configured to communicate with the computer the program system and/or the installation package.

The safety device may also be configured to avert lifting a truck when the container fails to decouple from the chassis carrying the container and pulled by the truck. The quay crane may also be configured to avert a container identification failure event for an Optical Character Recognition (OCR) system associated with the crane in response to the quay crane lifting the hatch cover off of the ship.

### BRIEF DESCRIPTION OF THE DRAWINGS

FIG. 1 shows an example of a safety device for a quay crane configured to lift a container from a hatch cover on a ship. The safety device is configured to avert the hatch cover being lifted as shown in this Figure in response to an indication that the container failed to decouple from the hatch cover, which will be discussed shortly.

FIG. 2A shows a simplified view of the situation prior to lifting the container, FIG. 2B shows the safe situation where the container has decoupled from the hatch cover, and FIG. 2C shows that the container may fail to decouple from the hatch cover while the hatch cover is still coupled to at least one other container.

FIG. 3 shows the safety device may include a processor configured to respond to at least one signal to create the indication that the container failed to decouple from the hatch cover and to generate the alert in response to the indication when the container is lifted off of the ship.

FIG. 4 shows some details of the alerts.

FIGS. 5A to 5D show several forms of interactions between the processor and various interfaces to receive the signal of FIG. 3, from at least one of the motion sensor and/or machine state sensors.

FIG. 6 shows the machine state sensor may include a trolley sensor, a hoist motor state sensor, and/or a load cell sensor.

FIG. 7 shows the safety device may also be operated to estimate the motion of the truck to create a track motion estimate when the truck is coupled to a chassis carrying a container and the spreader of the quay crane lifts the container. The safety device may avert the truck being jostled possibly by generating at least one of the alerts.

FIG. 9 shows a simplified block diagram of the motion sensor.

### DETAILED DESCRIPTION

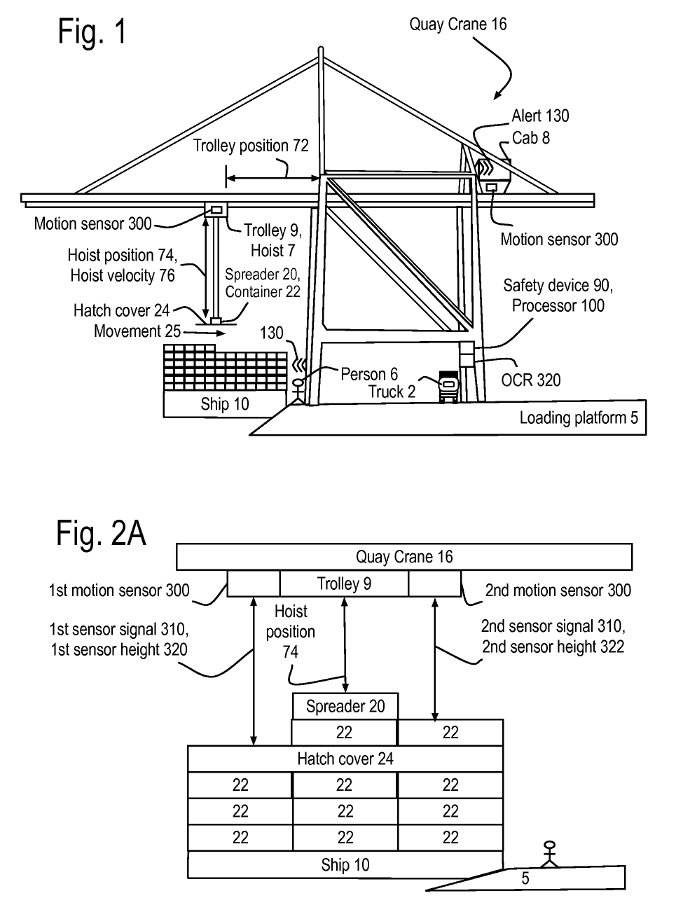

This invention relates to avoiding lifting a hatch cover on a ship as a quay crane picks up a container. A safety device is claimed and disclosed for a quay crane configured to lift a container from a hatch cover on a ship. The safety device may be configured to avert the hatch cover being lifted as shown in FIG. 1 in response to an indication that the container failed to decouple from the hatch cover.

Referring more specifically to the Figures with reference numbers, FIG. 1 shows an example of the safety device 90 for the quay crane 16 configured to lift the container 22 from the hatch cover 24 on the ship 10. The safety device is configured to avert the hatch cover being lifted as shown in this Figure in response to an indication that the container failed to decouple from the hatch cover, which will be discussed shortly. The quay crane typically includes a trolley 9 that positions a hoist 7 that controls the positioning of a spreader 20 that couples to the container to lift and move the container between the ship and a truck 2 or rail car, which is not shown. The safety device may respond to the indication that the hatch cover is coupled to the container being lifted by generating one or more alerts 130, which may be heard by at least one person 6 on the loading platform 5 and/or near the quay crane. The alert may be received in the cab 8 of the quay crane where the crane operator may override the current activities to avert the lifting of the hatch cover. In some embodiments, the safety device may initiate an automated engine or motor shutdown of the hoist 7 and possibly also halt any movement of the trolley. The ship may receive an alert that the hatch cover did not decouple from the container so that the situation may be fixed.

Note that in some embodiments, the safety device 90 may be configured to use at least one motion sensor 300 that may contribute to estimating the movement 25 of the hatch cover 24. In certain situations, the motion sensor may be configured to couple to the quay crane 16. For example, the motion sensor may be configured to couple to the trolley 9 and/or to the cab 8.

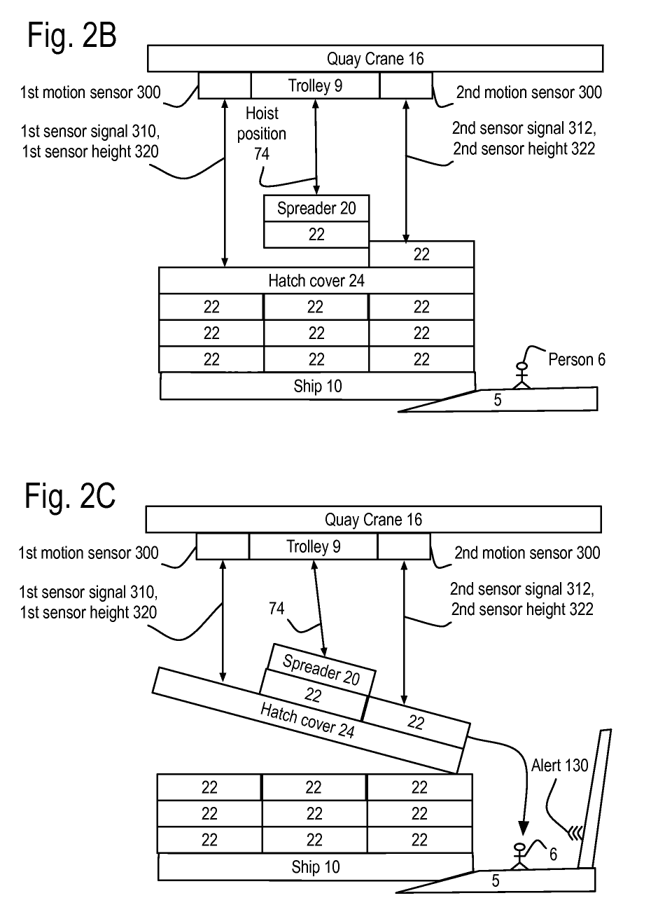

The hatch cover 24 is being lifted because the container is being lifted by the spreader 20. A first motion sensor 300, as shown in FIGS. 2A to 2C, generates the first motion sensor signal 310 that is used to estimate the first sensor height 320. The second motion sensor 300 generates the second sensor signal 312 used to estimate the second sensor height 322. The spreader lifting the hatch cover is indicated when the first sensor height and the second sensor height essentially keep up with the hoist position 74. As used herein keeping up that changes in the hoist position occur with comparable changes in the sensor heights 320 and 322, to within at most ten percent and possibly less, such as a fixed minimum height difference such as at most six feet, possibly three feet and further possibly at most (not more than) two feet.

FIG. 2A shows a simplified view of the situation prior to lifting the container 22. Two motion sensors 300 are coupled to the trolley 9 and both are used to produce a sensor signal 310 that contributes a sensor height 320. While other embodiments may only use one motion sensor and/or use moveable beam motion sensors, the discussion in these Figures will focus on this configuration as being the simplest to discuss, however, these other configurations may operate in a similar manner and are intended as part of the scope of the claims. Note that the hoist position 74 is different from the first and second sensor heights 320 and 322. This may be taken as the baseline for the following Figures.

FIG. 2B shows the safe situation where the container 22 has decoupled from the hatch cover 24 and the hoist position 74 is changing while the first sensor height 320 and second sensor height 322 remain essentially constant with the relative motion of the ship 10. In this situation, there is no alert being sent to the person 6 on the loading platform 5.

The indication that the container 22 failed to decouple from the hatch cover 24 may further include a second indication that the hatch cover is still coupled to at least one other container as shown in FIG. 2C. Here the hoist position 74, the first sensor height 320 and the second sensor height 322 may all be changing both individually and in relationship to each other. In this situation, the second container 22 may become decoupled from the hatch cover possibly harming the person 6. The safety device 90 generates at least one alert 130 to warn the person. The warning may be the same for both of the situations shown in FIG. 1 and FIG. 2C, or they may differ.

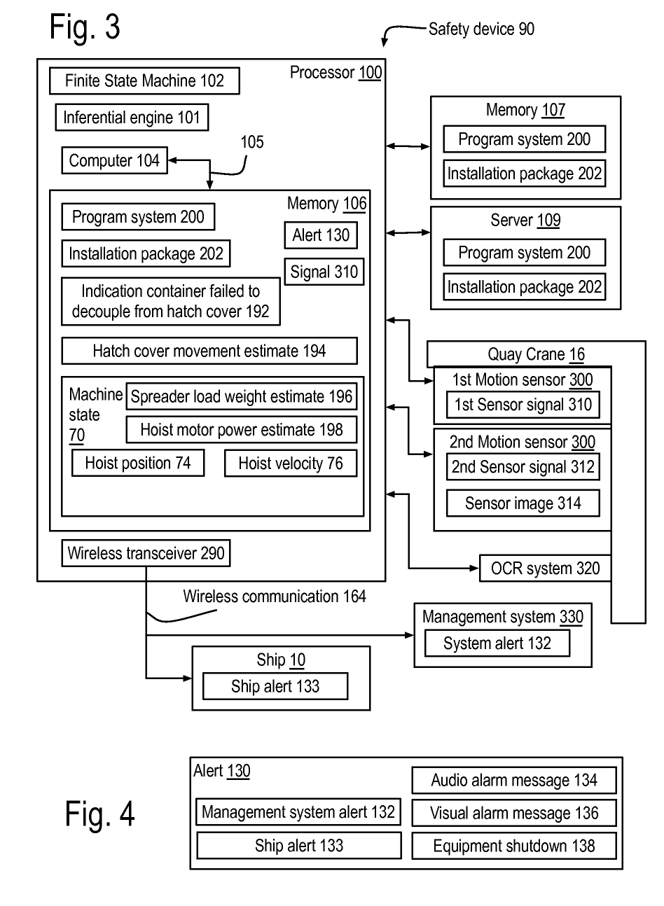

FIG. 3 shows the safety device 90 may include a processor 100 configured to respond to at least one signal 310 to create the indication 192 that the container 22 failed to decouple from the hatch cover 24 and to generate the alert 130 in response to the indication when the container is being lifted off of the ship 10.

The processor 100 may at least one instance of at least one of a finite state machine 102, a computer 104 accessibly coupled 105 with a memory 106 containing a program system 200 including program steps to instruct the computer, and an inferential engine 101.

Several of these terms will now be discussed briefly. The finite state machine 102 may receive at least one input, maintain-update at least one state and generate at least one output based upon a value of at least one of the input and the state. The computer 104 may include at least one data processor and at least one instruction processor with each of the data processors instructed by at least one of the instruction processors. The inferential engine 101 may maintain at least one inferential rule and infer from the inferential rule at least one fact.

The indication 192 that the container 22 failed to decouple from the hatch cover 24 may be based upon one or more of a hatch cover movement estimate 194, a spreader load weight estimate 196, a hoist position 74, a hoist velocity 76, and a hoist motor power consumption 198, any or all of which may be included in a machine state 70.

The alert 130 may be generated by the processor 100 and may be sent to not only the person 6 and the cab 8 shown in FIG. 1, but also to a management system 330 and/or to the ship 10. The safety device 90 and/or the processor 100 may include a wireless transceiver 290 configured to wirelessly communicate 164 with the management system 330 and/or the ship 10.

The motion sensors 300 may be coupled to the quay crane 16 and/or the OCR system 320 may communicate with the safety device 90 to contribute to the hatch cover movement estimate 194.

The motion sensor 300 may generate at least one sensor signal 310. In situations where multiple motion sensors may be installed for examples by coupling to two ends of the trolley 9, one of these sensors, for example the second motion sensor may generate a second sensor signal 312 that may either include a sensor image 314 generating by an imaging device 308 and/or the sensor image may be separately generated and sent to the safety device 90 and/or the processor 100. The processor may use the sensor image to determine if the truck 2 is coupled to the chassis 3 as well as at least partly determine a truck motion estimate. In certain embodiments, the processor may store more than one sensor reading and/or sensor image to create the hatch cover movement estimate and/or the truck motion estimate.

FIG. 4 shows some details of the alerts 130 as messages that may include a management system alert 132, a ship alert 133, an audio alarm message 134, a visual alarm message 136 and/or an equipment shutdown message 138. Note that in particular, the audio alarm message and/or the equipment shutdown message may include a digital and/or an analog component. Note that the system alert message 132 may include an indication to avert a container identification failure regarding the OCR system 320.

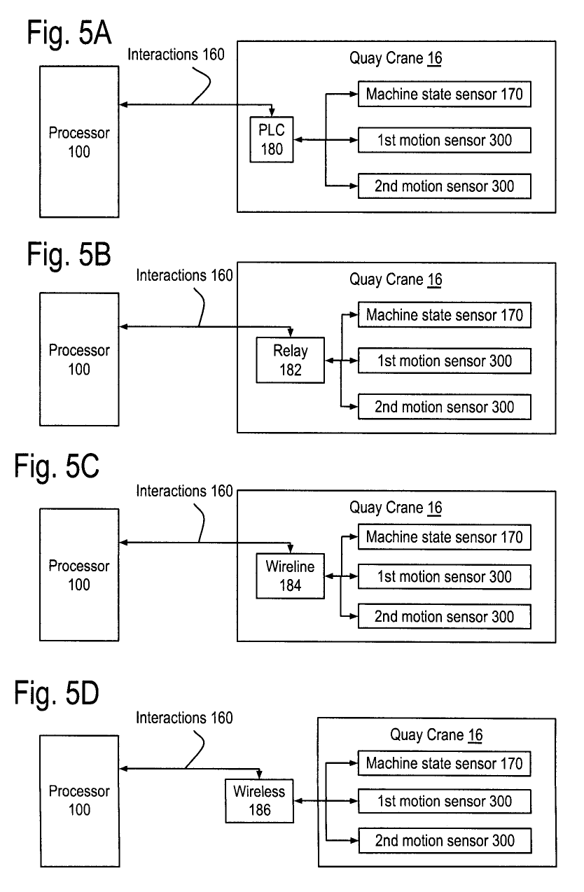

FIGS. 5A to 5D show several forms of interactions 160 between the processor 100 and various interfaces 180, 182, 184 and 188 to receive the signal 310 of FIG. 3, from at least one of the motion sensor and/or machine state sensors 170 any or all of which may be included in the operation of the safety device 90 and/or of the quay crane 16. FIG. 5A shows the interactions between a Programmable Logic Controller (PLC) interface 180. FIG. 5B shows a relay interface 182. FIG. 5C shows a wireline communications interface 184 compatible with at least one wireline communications standard. And FIG. 5D shows a wireless communications interface 186 compatible with at least one wireless modulation-demodulation scheme.

The wireline communications standard may include a version of at least one of a Synchronous Serial Interface (SSI) protocol, an Ethernet protocol, a Serial Peripheral Interface (SPI), an RS-232 protocol, an Inter-IC (I2C) protocol, an Universal Serial Bus (USB) protocol, a Controller Area Network (CAN) protocol, a Firewire protocol, the Institute for Electrical and Electronic Engineers (IEEE) 1394 communications standard, an RS-485, and/or an RS-422 protocol.

The wireless modulation-demodulation scheme may include at least one of a Time Division Multiple Access (TDMA) scheme, a Frequency Division Multiple Access scheme (FDMA), a Spread Spectrum Scheme including at least one of a Code Division Multiple Access (CDMA) scheme, a Frequency Hopping Multiple Access (FHMA) scheme, a Time Hopping Multiple Access (THMA) scheme, and/or an Orthogonal Frequency Division Multiple access (OFDM) scheme.

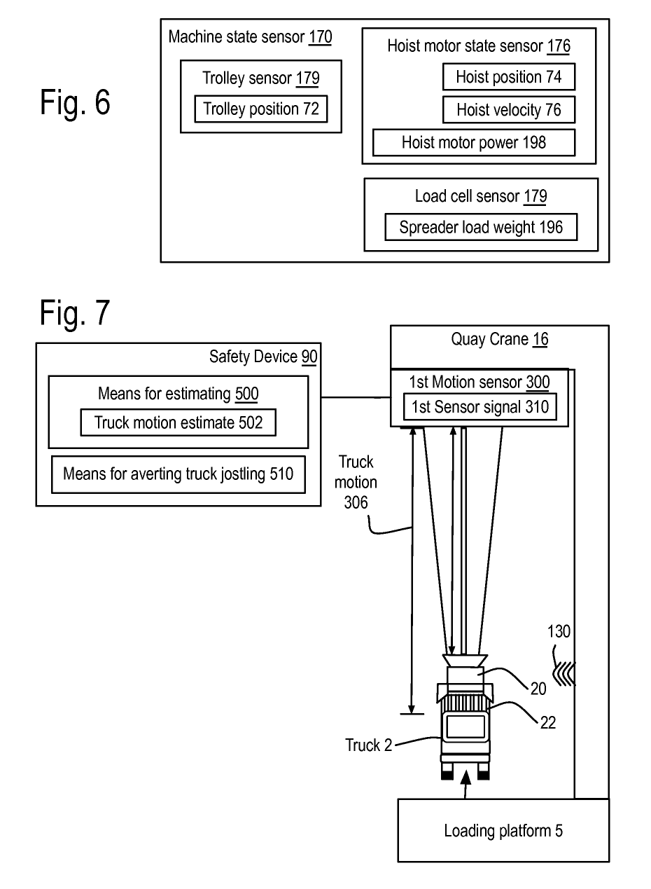

FIG. 6 shows the machine state sensor 170 may include a trolley sensor 179, a hoist motor state sensor 176, and/or a load cell sensor 179. The trolley sensor 179 may be used to generate the trolley position 72.

The hoist motor state sensor 176 may contribute to the hoist position 74, the hoist velocity 76 and/or the hoist motor power 198. The hoist motor state sensor may include multiple sensors, such as an electrical voltage or current measurement circuit and an optical shaft encoder. A hoist motor state sensor may read a gray scale coded wheel mounted in the hoist drum or on its axle that is used to calculate the hoist position 74 and the hoist velocity 76.

The load cell sensor 179 may contribute to the spreader load weight 196 and may use a strain gauge, possibly coupled to the hoist cable and the spreader 20.

The machine state sensor 170 may further include at least one instance of at least one of the following: A spreader state sensor for the spreader state.

FIG. 7 shows the safety device 90 may also be operated to estimate 500 the motion 306 of the truck 2 to create a track motion estimate 502 when the truck is coupled to a chassis carrying a container 22 and the spreader 20 of the quay crane 16 lifts the container. The safety device may avert 510 the truck being jostled possibly by generating at least one of the alerts 130. These operations are more fully disclosed in U.S. patent application Ser. No. 12/748,354, entitled “GANTRY CRANE TRUCK JOSTLE PREVENTION AND/OR HATCH COVER DETECTION” by the same inventors, which has been incorporated herein by reference earlier in this patent application.

The next Figure shows a flowchart of some details of the program system 200 instructing the processor 100. These flowcharts show some method embodiments, which may include arrows signifying a flow of control and/or state transitions as well as sometimes position data, supporting various implementations. These may include a program operation, or program thread, executing upon the computer 104 or states of the finite state machine 102. Each of these program steps may at least partly support the operation to be performed. The operation of starting a flowchart refers to entering a subroutine or a macroinstruction sequence in the computer or of a possibly initial state or condition of the finite state machine. The operation of termination in a flowchart refers to completion of those operations, which may result in a subroutine return in the computer or possibly return the finite state machine to a previous condition or state. A rounded box with the word “Exit” in it denotes the operation of terminating a flowchart.

FIG. 8 shows a flowchart of the program system 200 that supports the safety device 90 and/or the processor 100 being configured to configured to avert the hatch cover from being lifted in response to an indication that the container failed to decouple from the hatch cover by the inclusion of at least one of the following.
Program step 202 supports responding to the signal 310 to create the indication 192 that the container 22 failed to decouple from the hatch cover 24. As previously stated, the indication 192 may be based upon the hatch cover movement estimate 194, the spreader load weight estimate 196, the hoist position 74, the hoist velocity 76, and/or the hoist motor power consumption 198, any or all of which may be included in a machine state 70. These various signals and estimates may be based upon the interactions 160 with any combination of a PLC interface 180, a relay interface 182, a wireline interface 184 and/or a wireless interface 186.
Program step 204 generates the alert 130 in response to the container 22 being lifted by the quay crane and the indication 192 that the container failed to decouple from the hatch cover 24. As previously stated, the alert(s) may be heard by at least one person 6 on the loading platform 5 and/or near the quay crane 16. The alert may be received in the cab 8 of the quay crane where the crane operator may override the current activities to avert the lifting of the hatch cover. In some embodiments, the safety device may initiate an automated engine or motor shutdown of the hoist 7 and possibly also halt any movement of the trolley. The ship 10 may receive an alert that the hatch cover did not decouple from the container so that the situation may be fixed. And the management system 332 may also receive a version of the alert.

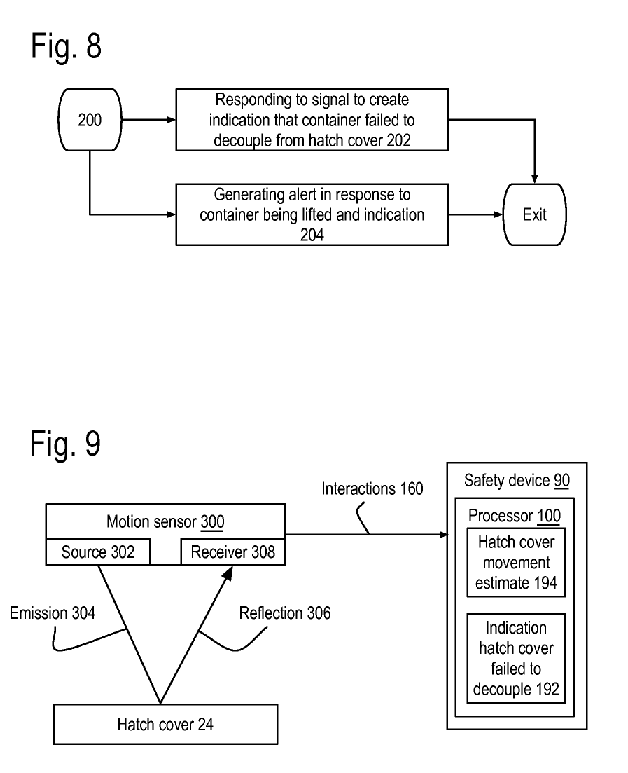

FIG. 9 shows a simplified block diagram of the motion sensor 300 that may include at least one source 302 configured to produce an emission 304 that reflects off of the hatch cover 24 to create a reflection 308 and at least one receiver configured to receive the reflection to at least partly create the hatch cover movement estimate 194 used by the safety device 90 and/or the processor 100 to possibly create the indication 192 that the hatch cover failed to decouple from the container 22. The emission may include any combination of at least one of an ultrasonic component, a microwave component, an infrared component, and/or a visible light component. By way of example, the source and/or the receiver may be implemented with a laser for the visible light component. The source and/or the receiver may be implemented with a radar for the microwave component.

The preceding embodiments provide examples and are not meant to constrain the scope of the following claims.

What is claimed is:

1. A safety device for a quay crane configured to lift a container from a hatch cover on a ship, comprising:
said safety device configured to avert said hatch cover from being lifted in response to an indication that said container failed to decouple from said hatch cover.

2. The safety device of claim 1, wherein said indication further includes a second indication that said hatch cover is also coupled to at least one other of said containers.

3. The safety device of claim 1, wherein said indication is based upon at least one of a hatch cover movement estimate, a spreader load weight estimate, a hoist position, a hoist velocity, and a hoist motor power consumption.

4. The safety device of claim 3, comprising a processor configured to respond to at least one signal to create said indication that said container failed to decouple from said hatch cover and to generate an alert in response to said indication.

5. The safety device of claim 4, wherein said alert contributes to at least one of
averting said hatch cover being lifted,
warning people said hatch cover is coupled to said container being lifted,
shutting down at least one equipment involved in lifting said container, and
informing at least one of said ship and a management system that said hatch cover is coupled to said container being lifted.

6. The safety device of claim 4, wherein said alert include at least one of an audio alert, a visual alert, an engine stop signal, a ship alert, and a management system alert.

7. The safety device of claim 4, wherein said processor is further configured to receive said signal through interactions with at least one of a Programmable Logic Controller (PLC) interface, a relay interface, a wireline communications interface compatible with at least one wireline communications standard, and a wireless communications interface compatible with at least one wireless modulation-demodulation scheme.

8. At least one motion sensor for said safety device of claim 7, configured to send said signal via said interactions to at least partly create a hatch cover movement estimate.

9. The motion sensor of claim 8, further configured to couple to said quay crane.

10. The motion sensor of claim 9, further configured to couple to at least one of a cab and a trolley, each included in said quay crane.

11. The motion sensor of claim 8, comprising
at least one source configured to produce an emission that reflects off of said hatch cover to create a reflection; and
at least one receiver configured to receive said reflection to at least partly create said hatch cover movement estimate.

12. The motion sensor of claim 11, wherein said emission includes at least one of an ultrasonic component, a microwave component, an infrared component, and a visible light component.

13. The safety device of claim 4, wherein said processor includes at least one instance of at least one of a finite state machine, a computer instructed by a program system including program steps residing in a memory accessibly coupled to said computer and an inferential engine.

14. The safety device of claim 13,
wherein said finite state machine receives at least one input, maintains-updates at least one state and generates at least one output based upon a value of at least one of said input and said state;
wherein said computer includes at least one data processor and at least one instruction processor with each of said data processors instructed by at least one of said instruction processors; and
wherein said inferential engine maintains at least one inferential rule and infers from said inferential rule at least one fact.

15. The safety device of claim 13, wherein said program system includes at least one of said program steps of:
responding to said signal to create said indication that said container failed to decouple from said hatch cover; and
generating said alert in response to said container being lifted and said indication that said container failed to decouple from said hatch cover.

16. At least one of a computer readable memory and a server,
wherein said computer readable memory is configured for accessible coupling to said computer of claim 13, including at least one of said program system and an installation package containing at least one instruction to configure said memory with said program system; and
wherein said server is configured to communicate to said computer at least one of said program system and said installation package.

17. The safety device of claim 1, wherein said quay crane is further configured to lift said container from a chassis coupled to a truck; and
wherein said safety device is further configured to avert said truck from being lifted in response to said quay crane lifting said container and an indication said container has failed to decouple from said chassis.

18. A processor, comprising: said processor configured to avert a hatch cover from being lifted by a quay crane as said quay crane lifts a container from said hatch cover on a ship in response to an indication that said container failed to decouple from said hatch cover.

19. The processor of claim 18, comprises at least one instance of at least one of a finite state machine, a computer accessibly coupled with a memory containing a program system including program steps to instruct said computer, and an inferential engine.

20. The processor of claim 19,
wherein said finite state machine receives at least one input, maintains-updates at least one state and generates at least one output based upon a value of at least one of said input and said state;
wherein said computer includes at least one data processor and at least one instruction processor with each of said data processors instructed by at least one of said instruction processors; and
wherein said inferential engine maintains at least one inferential rule and infers from said inferential rule at least one fact.

21. The safety device of claim 18, wherein said indication is based upon at least one of a hatch cover movement estimate, a spreader load weight estimate, a hoist position, a hoist velocity, and a hoist motor power consumption.

22. The processor of claim 19, wherein said program system includes at least one of the program steps of:
responding to at least one signal to create said indication that said container failed to decouple from said hatch cover; and
generating said alert in response to said container being lifted and said indication that said container failed to decouple from said hatch cover.
